(19) United States
(12) Patent Application Publication
(10) Pub. No.: US 2023/0146292 A1
(43) Pub. Date: May 11, 2023

(54) MULTI-TASK MACHINE LEARNING WITH HETEROGENEOUS DATA

(71) Applicant: Microsoft Technology Licensing, LLC, Redmond, WA (US)

(72) Inventors: Sen ZHOU, Cupertino, CA (US); Dansong ZHANG, Santa Clara, CA (US); Yan ZHANG, Santa Clara, CA (US); Hongyi SHI, Santa Clara, CA (US); Tong ZHOU, Sunnyvale, CA (US); Anastasiya KARPOVICH, San Leandro, CA (US); Yunsong MENG, Cupertino, CA (US); Tie WANG, San Jose, CA (US)

(21) Appl. No.: 17/521,803

(22) Filed: Nov. 8, 2021

(51) Int. Cl. G06N 3/04

(52) U.S. Cl. CPC G06N 3/0454

(57) ABSTRACT

Embodiments of the disclosed technologies receive, for a first machine learning task, a first set of raw features arranged according to a first schema, and, for a second machine learning task, a second set of raw features arranged according to a second schema different than the first schema. A multi-task raw feature set is created by storing, in a data store arranged according to a common schema, the first and second sets of raw features. A common feature that is common to both the first and second sets of raw features is identified. A multi-task transformed feature set and a model bundle are created. The multi-task transformed feature set is separated into first and second sets of transformed features. The first and second sets of transformed features and the model bundle can be used to create a trained multi-task machine learning model.

### TECHNICAL FIELD

A technical field to which the present disclosure relates is multi-task machine learning. Another technical field to which this disclosure relates is the training of multi-task machine learning models. Yet another technical field to which this disclosure relates is the generation of training data sets for multi-task models using heterogeneous data.

### BACKGROUND

Machine learning is a category of artificial intelligence. In machine learning, a model is created using a machine learning algorithm. A machine learning algorithm is a mathematical and/or logical expression of a relationship between inputs to and outputs of the machine learning model. The model is trained by applying the machine learning algorithm to training data.

A trained model can be applied to new instances of input data. In response to a new instance of input data, a machine learning model can output a prediction, a score, a classification, or an inference. Application systems can use the output of a trained machine learning model to determine downstream execution decisions.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a multi-task learning system in accordance with some embodiments of the present disclosure.

FIG. 2 is an example of an application system that includes a multi-task learning system in accordance with some embodiments of the present disclosure.

FIG. 3 is a flow diagram of an example method to generate training data for a multi-task machine learning model in accordance with some embodiments of the present disclosure.

FIG. 4 is an example of a data preparation flow in accordance with some embodiments of the present disclosure.

FIG. 5 is an example of a multi-task learning flow in accordance with some embodiments of the present disclosure.

FIG. 6A and FIG. 6B are examples of machine learning model architectures for multi-task learning in accordance with some embodiments of the present disclosure.

FIG. 7 is a block diagram of an example computer system in which embodiments of the present disclosure can operate.

### DETAILED DESCRIPTION

User-facing functionality of an application system can be supported by machine learning models. For example, output of a machine learning model can be used to select search suggestions to be displayed by an application system in a search portion of a user interface. Output of another machine learning model can be used to control the order in which search results are displayed on a user interface. Output of still other machine learning models can be used to select recommendations to display in a feed or recommendation portion of a user interface, such as a news feed or a “people you may know,” “jobs you may be interested in,” “organizations you may be interested in,” or “products you may be interested in” section of the user interface.

A multi-task machine learning model is a machine learning model that is trained for multiple different but related machine learning tasks. Machine learning tasks can be considered related, even if they are in different domains or serve different downstream applications, if the tasks have at least some training data, features, machine learning model parameters and/or coefficients in common.

As used herein, machine learning task can refer to a data processing task that is implemented using machine learning or which uses the output of a machine learning model to perform another task. An example of a data processing task that can be implemented using machine learning is smart search suggestions.

In one example, an application system can, based on output of a machine learning model, generate and display search suggestions for each of several different but related entities. Entity as used herein can refer to a category of data, such as people, companies, and jobs, which can be implemented using a data structure such as a data object, a table, a field, or a column of a table.

If a user inputs a search criterion into, for example, a facet-based search interface or a natural language-based search interface, the application system can, based on the output of a machine learning model, automatically generate and display, in the search interface, one or more suggested entity values to add as search terms to the user’s search. For instance, if a user inputs a job title with the intent of searching for jobs matching that job title, the application system can generate suggestions for adding an alternative job title, a suggested company name or a suggested geographic location to the user’s search. In search suggestion applications, the system-generated suggestions are not automatically added to the user’s query; rather, those suggestions are only added to the user’s query if the user takes some action in the user interface to accept the suggestions.

Other smart suggestion approaches use single-task machine learning models to generate entity-specific search suggestions. For example, a jobs model is trained to generate job suggestions and a company model is trained to generate company suggestions. However, as described below, smart search suggestions is one example of a machine learning task that can be implemented using a multi-task machine learning model. For example, if the task of generating job suggestions and the task of generating company suggestions are determined to be related, a single multi-task machine learning model can be trained to perform both of these tasks.

In other examples, different types of machine learning tasks can be considered related if they involve a common entity. For instance, search suggestion scoring and search result ranking tasks can be related by a common entity (e.g., a job search and a ranked list of recommended job candidates both involve a job entity). These different but related tasks can be implemented using multi-task learning, as well.

However, there are several technical challenges to effectively implementing multi-task learning. One technical challenge is the proper handling of heterogeneous training data. Heterogeneous data can become an issue when the training data for different machine learning tasks comes from different domains or has different schemas, keys and/or features.

Feature as used herein can refer to an input to a machine learning model. Machine learning model features can include raw data items, such as the actual text input by a user into a search input box of a user interface, which can be referred to as raw features. Features can, alternatively or in addition, include data items that are the result of one or more computations or transformations that have been performed on raw data items, and these features can be referred to as transformed features. Transformed features also can be derived from previously transformed features rather than directly from raw features.

Another technical challenge to successfully implementing multi-task learning is that different machine learning tasks can have different loss functions. For example, one machine learning task can be configured with a pointwise ranking loss function while a different but related machine learning task is configured with a listwise ranking loss function.

Loss function as used herein can refer to a function that can be used to compute machine learning model error (e.g., a comparison of model-generated values to validated or ground-truth values) at a particular iteration, node, or layer of the model. Output of the loss function is used by the machine learning model to determine whether the machine learning model is producing reliable output or whether any model parameter values and/or coefficient values need to be adjusted in order to improve the model’s output.

Different types of loss functions can require different training data. For example, a pointwise loss function uses two-dimensional training data while a listwise loss function uses three-dimensional training data. These differences can limit the extent to which layers of the machine learning model can be shared across the different machine learning tasks, which can negatively impact the utility of the multi-task model versus other approaches.

Another technical challenge to implementing multi-task learning is that different machine learning tasks may or may not be able to share certain layers of the machine learning model. As used herein, sharing, or sharing of layers, can refer to a model architecture in which the outputs of a model layer are used across multiple different machine learning tasks.

Different machine learning tasks can have different sharing requirements or limitations. For example, hard sharing can be suitable for some types of related tasks but not others. As used herein, hard sharing can refer to a multi-task machine learning model structure in which one or more layers of the model use the same coefficients for all of the different machine learning tasks for which the model is trained. Soft sharing can be used in place of hard sharing. Soft sharing as used herein can refer Soft sharing as used herein can refer to a multi-task machine learning model structure in which different tasks can share the same layers but still have different coefficients and/or parameters. Additional regularization terms or other methods may be applied upon these coefficients and/or parameters, for the purpose of limiting the differences in the coefficients and/or parameters among the different tasks.

The fact that different machine learning tasks often have different schemas, loss functions, parameters, coefficients, and/or sharing requirements or limitations can limit the adoption of multi-task learning systems. These and other challenges can increase the complexity of multi-task training and slow down the speed at which a multi-task machine learning model can be trained. The complexity of multi-task training and slow training process can be significant barriers to the adoption of multi-task learning technologies.

Aspects of the present disclosure address the above technical challenges and/or other deficiencies of other approaches. As described in more detail below, embodiments create a multi-task machine learning model, merge heterogeneous, task-specific raw feature sets into a common schema, apply feature transformations to the merged raw feature sets, split the transformed feature sets into task-specific transformed feature sets, and store the task-specific transformed feature sets and a model bundle collectively for access and use by multiple different downstream applications.

The model bundle contains the specifications for the feature transformations for all of the tasks for which the multi-task machine learning model is trained. When the multi-task machine learning model is trained for a particular target task (such as a scoring model or a ranking model), only the set of features specific to that target task (and not all of the features) are used as inputs to train the multi-task model for the particular target task. After being trained for all of the multiple tasks, only one model bundle is needed/exported/used to serve any given target task (e.g., a smart suggestion task). Alternatively or in addition, the task-specific feature sets and model bundle can be used as inputs to a fine-tuning process specific to a particular target task (e.g., a smart suggestion task)..

As used herein, feature set can refer to a collection of instances of feature values. For example, a raw feature set for a company feature can contain all of the names of companies searched by a user within a particular time interval, while a raw feature set for a job feature can contain all of the job titles of jobs applied for by a user within a specific time interval. A transformed feature set as used here can refer to a raw feature set to which a feature transformation has been applied.

For example, a transformed feature set for a company feature can contain a smaller subset of all of the company names contained in the company raw feature set. That is, a raw feature set can contain more raw data than is actually used to train a machine learning model. In other words, some of the raw data in the raw feature set may not be used as features for machine learning model training. In some implementations, a raw feature set can be referred to as simply a data set, however, the term feature is used herein to indicate that the raw data is collected for the purpose of preparing inputs for a machine learning model.

Experiments have shown that embodiments of the disclosed approaches have improved the speed of multi-task machine learning model training by making training iterations run faster. For example, in one experiment, training speed was improved from 100 examples/second to 9,000 examples/second.

A beneficial result of using the disclosed multi-task learning approaches for entity search suggestions is that the search suggestions produced with the multi-task model have been shown to be less dependent on historical entity popularity, as measured by frequency of use of the entity as a search term, than with other approaches. As a result, using the disclosed approaches, historically less popular entities, such as smaller or less well-known companies or job titles, are more likely to be included in search suggestions than with other approaches. The improvements in training speed provided by the disclosed technologies can increase the adoption of multi-task learning, which in turn can increase the chances that users will experience these and/or other beneficial improvements in the downstream applications.

The disclosed technologies can be described with reference to an example use case of training a machine learning model to generate multiple different types of entity co-occurrence predictions, which can be used by downstream applications to generate search suggestions for multiple different entity types. However, aspects of the disclosed technologies are not limited to entity co-occurrence predictions or to entity search suggestions but can be used to generate predictions and/or search suggestions, more generally.

For example, aspects of the disclosed technologies can be used to generate activity predictions related to multiple different entities and actions. Training data for a machine learning model used to predict whether a particular user is likely to apply for a particular job can include entity data for particular job candidates, historical activity data for those candidates, such as historical job searches and job application activities, and entity data for particular companies and job titles.

As another example, aspects of the disclosed technologies can be used to improve the ranking or sorting of entities or content items in a result set. For instance, a system that enables recruiters to search for candidates to fill job positions can use the disclosed approaches to sort lists of candidates in a manner that potentially increases the diversity of candidates in those lists. The disclosed technologies can be used by many different types of network-based applications that include or are supported by multi-task machine learning models.

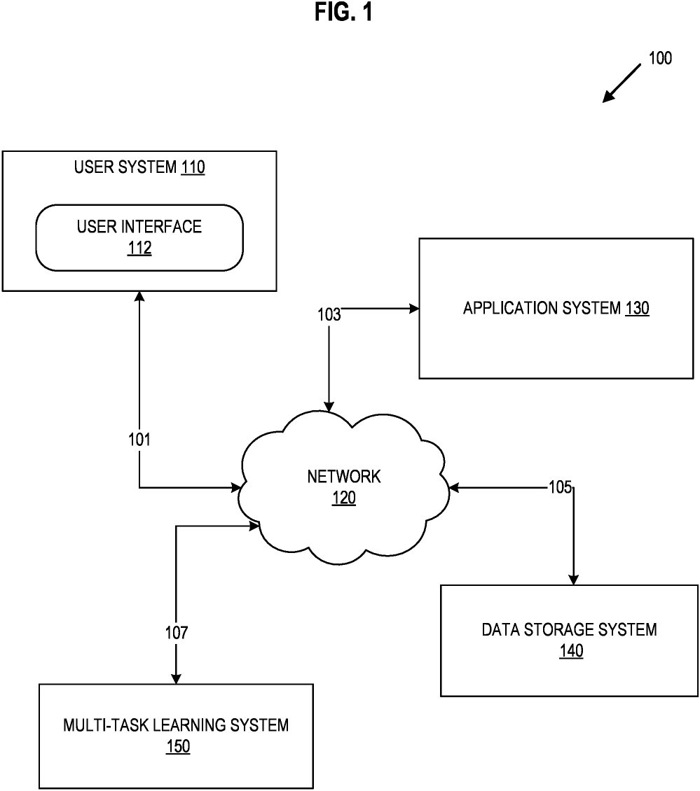

FIG. 1 illustrates an example computing system 100 that includes a multi-task learning system 150. In the embodiment of FIG. 1, computing system 100 includes a user system 110, a network 120, an application system 130, a data storage system 140, and multi-task learning system 150. In other embodiments, multi-task learning system 150 and/or portions thereof can be included in or considered to be part of application system 130. Likewise, in some embodiments, portions of data storage system 140 can be included in or considered part of application system 130 or multi-task learning system 150.

User system 110 includes at least one computing device, such as a personal computing device, a server, a mobile computing device, or a smart appliance. User system 110 includes at least one software application, including a user interface 112, installed on a computing device or accessible to a computing device by a network. For example, user interface 112 can be or include a front-end portion of application system 130, which can be implemented as a native application on a computing device or as a web application that launches in a web browser.

User interface 112 is any type of user interface as described above. User interface 112 can be used to input, upload, or share data, data records, and digital content items and/or to view or otherwise perceive data, data records, and digital content items distributed by application system 130. For example, user interface 112 can include a graphical user interface, haptic interface, and/or a conversational voice/speech interface that includes one or more mechanisms for viewing and manipulating digital content items.

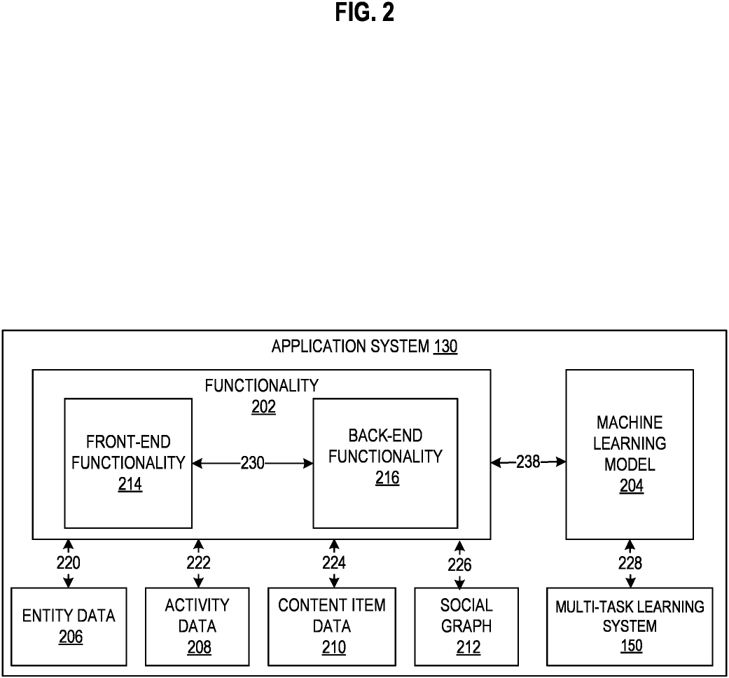

Application system 130 is any type of application software system that includes or utilizes functionality provided by multi-task learning system 150. Examples of application system 130 include but are not limited to connections network software, such as professional and/or general social media platforms, and systems that are or are not be based on connections network software, such as digital content distribution services, general-purpose search engines, job search software, recruiter search software, sales assistance software, advertising software, learning and education software, messaging software, e-commerce software, office productivity software, or any combination of any of the foregoing. An example embodiment of application system 130 is shown in FIG. 2, described below.

Data storage system 140 includes data stores and/or data services that store digital content items, data received, used, manipulated, and produced by application system 130, and data received, used, manipulated, and produced by multi-task learning system 150. Data storage system 140 can include multiple different types of data storage and/or a distributed data service. As used herein, data storage system or data service can refer to a physical, geographic grouping of machines, a logical grouping of machines, or a single machine. For example, a data service can be a data center, a cluster, a group of clusters, or a machine.

Data stores of data storage system 140 can be configured for real-time, near real-time (also referred to as nearline), and/or offline (e.g., batch) data processing. “Time” as used in the context of terminology such as real-time, near real-time, and offline, can refer to the time delay introduced by the use of computer technology, e.g., by automated data processing and/or network transmission, where the time delay is the difference in time as measured by a system clock, between the occurrence of an online event and the use of data processed in response to the event, such as for display, feedback, and/or control purposes.

A data store configured for real-time data processing can be referred to as a real-time data store. A data store configured for near real-time data processing can be referred to as a near real-time data store or nearline data store. A data store configured for offline or batch data processing can be referred to as an offline data store.

Real-time data processing involves a continual input, such as a live feed, immediate, constant processing of the data stream, and steady output in response to the continual input. Real-time data processing involves low-latency messaging and event processing. An example of real-time data processing is data streaming, where the streaming data is not persisted for further analysis. In real-time data processing, the acceptable processing time is seconds, sub-seconds or less (e.g., milliseconds). An example of a tool that can be used for real-time data processing is APACHE SPARK.

In contrast to real-time processing, near real-time data processing persists the incoming data and then processes the data. An example of a use of near real-time data processing is to combine data from multiple different data sources, for example to detect patterns or anomalies in the data. Examples of near real-time processing include processing sensor data, network monitoring, and online transaction processing. In near real-time data processing, the acceptable processing time is in the range of minutes or seconds. An example of a tool that can be used for near real-time, asynchronous data processing is APACHE SAMZA.

Offline or batch data processing is less time-sensitive than near real-time or real-time processing. In batch data processing, the acceptable processing time is in the range of days or hours. An example of a tool that can be used for batch data processing is APACHE HADOOP Distributed File System (HDFS).

Data stores can be implemented using databases, such as key-value stores, relational databases, and/or graph databases. Real-time data stores and nearline data stores can store real-time event streams such as KAFKA event streams. Data can be written to and read from data stores using query technologies, e.g., SQL or NoSQL.

A key-value database, or key-value store, is a nonrelational database that organizes and stores data records as key-value pairs. The key uniquely identifies the data record, i.e., the value associated with the key. The value associated with a given key can be, e.g., a single data value, a list of data values, or another key-value pair. For example, the value associated with a key can be either the data being identified by the key or a pointer to that data.

A relational database defines a data structure as a table or group of tables in which data are stored in rows and columns, where each column of the table corresponds to a data field. Relational databases use keys to create relationships between data stored in different tables, and the keys can be used to join data stored in different tables.

Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

Data storage system 140 can reside on at least one persistent and/or volatile storage device that can reside within the same local network as at least one other device of computing system 100 and/or in a network that is remote relative to at least one other device of computing system 100. Thus, although depicted as being included in computing system 100, portions of data storage system 140 can be part of computing system 100 or accessed by computing system 100 over a network, such as network 120.Multi-task learning system 150 can train multi-task machine learning models that can be used for multiple different machine learning tasks. Embodiments of multi-task learning system 150 can support both feature transfer and model transfer.

Feature transfer as used herein can refer to generating results (e.g. a 200-dimension embedding or a single-dimension score) from one machine learning task, and use of such results as features (or part of the features) to train a model for another machine learning task.. For example, in a feature transfer application, multi-task learning system 150 can act as an embedding service that generates multi-task embeddings that can be used to train downstream task-specific machine learning models.

In a model transfer application, a multi-task machine learning model trained by multi-task learning system 150 can function as a pre-trained model that can be served directly or fine-tuned by additional rounds of training with domain-specific and/or task-specific training data for particular downstream vertical applications. Multi-task learning system 150 can be implemented, for example, as a software application hosted on a server computing device or a network of server computing devices.

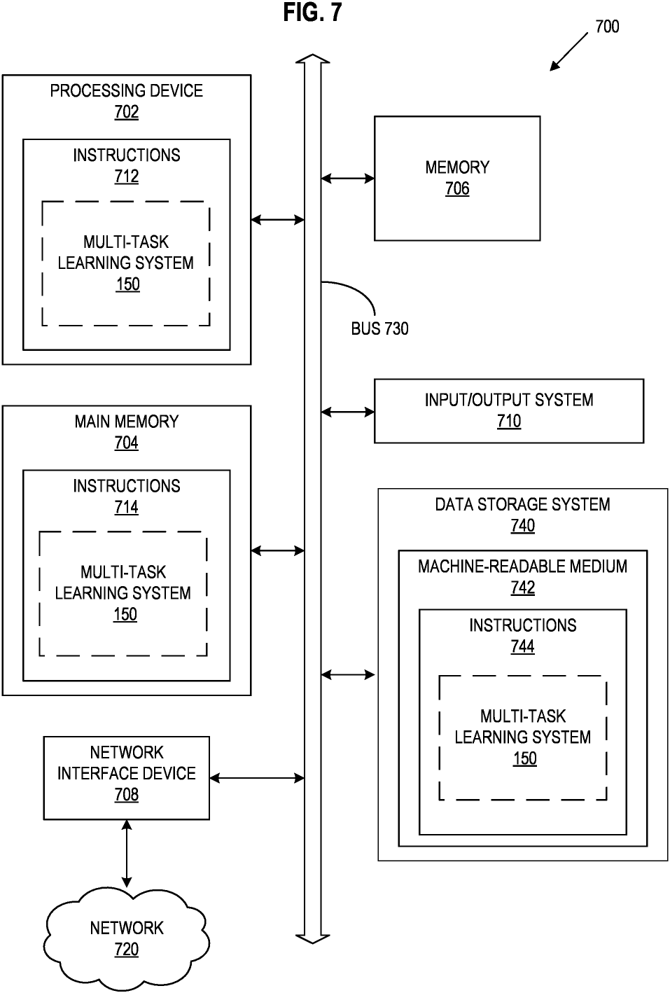

In some embodiments, such as shown in FIG. 2, application system 130 includes at least a portion of multi-task learning system 150. As shown in FIG. 7, multi-task learning system 150 can be implemented as instructions stored in a memory 704 or machine-readable medium 742, and a processing device 702 can be configured to read and execute the instructions stored in the memory to perform the operations described herein. Additional description of multi-task learning system 150 is provided below.

Any of user system 110, application system 130, data storage system 140, and multi-task learning system 150 includes an interface embodied as computer programming code stored in computer memory that when executed causes a computing device to enable bidirectional communication with any other of user system 110, application system 130, data storage system 140, and multi-task learning system 150 using communicative coupling mechanisms 101, 103, 105, 107. Examples of communicative coupling mechanisms include network interfaces, interprocess communication (IPC) interfaces and application program interfaces (APIs).

A client portion of application system 130 can operate in user system 110, for example as a plugin or widget in a graphical user interface of a software application or as a web browser executing user interface 112. In an embodiment, a web browser can transmit an HTTP request over a network (e.g., the Internet) in response to user input that is received through a user interface provided by the web application and displayed through the web browser. A server running application system 130 and/or a server portion of application system 130 can receive the input, perform at least one operation using the input, and return output using an HTTP response that the web browser receives and processes.

Other technologies that can be used to effectuate communications of data and/or instructions between any of user system 110, application system 130, data storage system 140, and multi-task learning system 150 include application programming interfaces (APIs) such as REST (representational state transfer) APIs and SOAP (simple object access protocol), scripting languages such as JavaScript, markup languages such as XML (extensible markup language) and JSON (JavaScript object notation), and AJAX (asynchronous JavaScript and XML).

Each of user system 110, application system 130, data storage system 140, and multi-task learning system 150 is implemented using at least one computing device that is communicatively coupled to electronic communications network 120 using communicative coupling mechanisms 101, 103, 105, 107. Any of user system 110, application system 130, data storage system 140, and multi-task learning system 150 can be bidirectionally communicatively coupled by network 120. User system 110 as well as one or more different user systems (not shown) can be bidirectionally communicatively coupled to application system 130.

A typical user of user system 110 can be an administrator or an end user of application system 130 and/or multi-task learning system 150. An administrator or an end user can be a human person or a computer program designed to simulate human use of application system 130, such as a bot. User system 110 is configured to communicate bidirectionally with any of application system 130, data storage system 140, and/or multi-task learning system 150 over network 120 using communicative coupling mechanism 101. User system 110 has at least one address that identifies user system 110 to network 120 and/or application system 130; for example, an IP (internet protocol) address, a device identifier, a MAC (media access control) address, a session identifier, a user account identifier, or any combination of any of the foregoing.

The features and functionality of user system 110, application system 130, data storage system 140, and multi-task learning system 150 are implemented using computer software, hardware, or software and hardware, and can include combinations of automated functionality, data structures, and digital data, which are represented schematically in the figures. User system 110, application system 130, data storage system 140, and multi-task learning system 150 are shown as separate elements in FIG. 1 for ease of discussion but the illustration is not meant to imply that separation of these elements is required. The illustrated systems, services, and data stores (or their functionality) can be divided over any number of physical systems, including a single physical computer system, and can communicate with each other in any appropriate manner.

Network 120 can be implemented on any medium or mechanism that provides for the exchange of data, signals, and/or instructions between the various components of computing system 100. For example, data and instructions can be represented as signals, where a signal includes a series of bits, and a bit value corresponds to a designated level of electrical charge that can traverse network 120 and be received and processed by devices on network 120. Examples of network 120 include, without limitation, a Local Area Network (LAN), a Wide Area Network (WAN), an Ethernet network, the Internet, at least one terrestrial, satellite or wireless link, or a combination of any number of different networks and/or communication links.

FIG. 2 is an example of an application system that includes a multi-task learning system in accordance with some embodiments of the present disclosure. In FIG. 2, application system 130 includes functionality 202, machine learning model 204, entity data 206, activity data 208, content item data 210, social graph 212, and multi-task learning system 150.

FIG. 2 shows machine learning model 204, entity data 206, activity data 208, content item data 210, social graph 212, and multi-task learning system 150 as part of application system 130 for ease of discussion. However, any one or more of machine learning model 204, entity data 206, activity data 208, content item data 210, social graph 212, and multi-task learning system 150 can be implemented outside of application system 130, for example as a network-based service. For example, any of machine learning model 204, entity data 206, activity data 208, content item data 210, social graph 212 can be implemented using or as part of data storage system 140.

Functionality 202 includes front-end functionality 214 and back-end functionality 216 Portions of functionality 202 enable data manipulations by users of application system 130, communications between different users of application system 130, and communications between users and application system 130.

Users of application system 130 can be represented as entities in application system 130. An entity in application system 130 is a logical construct that is linked with an address of a physical user system 110. A user system 110 can be associated with more than one entity in application system 130. For example, a physical user system 110 can be associated with multiple different logical account identifiers, and a logical account identifier in application system 130 can be associated with multiple different physical user systems 110 (e.g., a smartphone, a smartwatch, and a laptop). Examples of entity types include users, companies, organizations, jobs, content items, and activities. Data manipulations and communications performed by a user system 110 in application system 130 can be described with reference to an entity associated with the user system 110.

Front-end functionality 214 is implemented in computer programming code and includes functionality that is exposed to users of application system 130 through a user interface, such as a graphical user interface, voice/speech interface, haptic interface, camera, virtual-reality or augmented-reality interface, robotic interface, or any combination of the foregoing. Front-end functionality 214 includes, for example, user interface features and functions that enable users to scroll a feed of digital content items, enter and execute search queries, follow other entities, view, like, create, upload, share, forward, reply to, and save data, data records, and digital content items, including system-generated recommendations, in application system 130.

Front-end functionality 214 also includes, for example, user interface features and functions that enable users to view, like, add, edit, and delete comments and replies to comments on digital content items, and to view, send and receive messages with other users of application system 130. Front-end functionality 214 also can include, for example, user interface features and functions that enable users to view, like, share, and otherwise manipulate data, data records, and digital content items presented in a search result, a feed, a dashboard, a recommendation, a notification, or a message generated by application system 130.

In application system 130, front-end functionality 214 and back-end functionality 216 are enabled by Internet communications technologies. For example, front-end functionality 214 that enables viewing of a digital content item in application system 130 includes the sending and receiving of digital network messages between the user system viewing the digital content item and application system 130. Front-end functionality 214 that enables searching for, viewing and manipulation of data, a data record, or a digital content item in application system 130 includes the sending and receiving of digital network messages between the user system viewing and/or manipulating the data, data record, or digital content item and application system 130.

In some contexts, network messages can be referred to as requests. For instance, when a user interacts with a portion of front-end functionality 214 using an input/output mechanism such as a mouse, microphone, camera, or a touchscreen, the user’s computing device can send a request message to a portion of back-end functionality 214 that causes a portion of a user interface, e.g. a web page, and/or digital content, to be loaded on the user’s device, for example from cache memory on the user’s device or downloaded from a server. Also, front-end functionality 214 and back-end functionality 216 can be asynchronous.

Back-end functionality 216 is implemented in computer programming code and can include computer operations, such as data manipulations, execution of instructions, and communications, that support the front-end functionality 214. Back-end functionality 216 can include reading or querying data from a data store, such as entity data 206, activity data 208, content item data 210, and/or social graph 212, performing computations and/or transformations on data, and writing data and/or results of computations and/or transformations to a data store.

Back-end functionality 216 can include computer execution of machine learning algorithms that provide output that can be used by front-end functionality 214 to configure user interface output. Back-end functionality 216 can include execution of queries against one or more data stores. For example, back-end functionality 216 can include executing queries to determine the nth-degree connections of an entity in social graph 212, where n is a positive integer, or executing queries on one or more data stores to retrieve a search result, such as a set of job postings, a set of user profiles, or a set of digital content items.

Back-end functionality 216 can include execution of machine learning algorithms that provide output that can be used by front-end functionality 214 to configure and populate a search result, a feed, a dashboard, a notification, a message, a push notification, or a recommendation. Back-end functionality 216 can include executing edge queries and/or path queries against a graph database. Back-end functionality can include translating or converting data stored in one form of data structure to another form of data structure. Algorithms executed as part of back-end functionality 216 can include, e.g., rules engines, heuristics, and/or machine learning algorithms that have been trained using one or more data sets of training data.

Although not specifically shown, back-end functionality 216 can include at least one recommender that automatically generates recommendations for a user that can be displayed in a user interface by front-end functionality 214 as, for example, messages or push notifications. An example of a recommender is a job recommender system that automatically generates job recommendations for users based on characteristics of the users and/or historical user activity in the application system.

Another example of a recommender is a feed ranking system that ranks, orders, or groups digital content items for inclusion in a user’s feed. Another example of a recommender is a smart search suggestion system that generates search term suggestions for a user’s search. Another example of a recommender is a profile recommender system that generates entity profile recommendations for viewing or connection requests. Another example of a recommender is a digital content item recommender system that generates recommendations for digital content items to display on a portion of the user interface.

Back-end functionality 216 is in bidirectional digital communication with front-end functionality 214 via communicative coupling 230. Specific portions of front-end functionality 214 can be in bidirectional digital communication with one or more recommenders. For example, a search interface portion of front-end functionality 214 can issue a call to a search recommender for the search recommender to group, sort, filter, or rank a set of search results, and search recommender can return a grouped, sorted, filtered, or ranked set of search results to the search interface portion of front-end functionality.

As another example, a feed interface portion of front-end functionality 214 can issue a call to a feed recommender for the feed recommender to group, sort, filter, or rank a set of digital content items to populate a user’s feed, and feed recommender can return a grouped, sorted, filtered, or ranked set of digital content items to the feed interface portion of front-end functionality 214. Similar interactions between other portions of front-end functionality 214, such as connection recommendation and job recommendation portions of front-end functionality 214, and corresponding recommenders, can also occur. Thus, functionality 202 can include multiple different recommenders that each serve a different portion of front-end functionality 214.

Back-end functionality 216 is in bidirectional digital communication with machine learning model 204 via communicative coupling 238. For example, a portion of back-end functionality 216 can issue a call containing a request for model output to a machine learning model 204, and machine learning model 204 can return the requested model output to the portion of back-end functionality 216 that issued the call.

Back-end functionality 216 can be executed by a server computer or network of servers and/or portions of back-end functionality 216 can be implemented on a client device, e.g., a user system 110. Front-end functionality 214 can be executed by a client device, e.g., a user system 110 and/or portions of front-end functionality 214 can be implemented on a server computer or network of servers.

Machine learning model 204 can be implemented as a combination of data and computer code that reflects relationships between sets of inputs and the outputs produced by the application of a machine learning algorithm to those sets of inputs. After a machine learning model has been trained, these relationships between inputs and outputs are reflected in the values of the machine learning algorithm parameters and/or coefficients. For example, application of a machine learning algorithm to training data adjusts the values of machine learning model parameters and/or coefficients iteratively until parameter and/or coefficient values are found that produce statistically reliable output, e.g., predictions, classifications, inferences, or scores.

Machine learning algorithm can refer to a single algorithm applied to a single set of inputs, multiple iterations of the same algorithm on different inputs, or a combination of different algorithms applied to different inputs. For example, in a neural network, a node corresponds to an algorithm that is executed on one or more inputs to the node to produce one or more outputs. A group of nodes each executing the same algorithm on a different input of the same set of inputs can be referred to as a layer of a neural network. The outputs of a neural network layer can constitute the inputs to another layer of the neural network.

A deep neural network (DNN) can include an input layer, one or more hidden layers, and an output layer. The input layer receives and operates on one or more raw inputs and passes output to one or more hidden layers. The output layer receives and operates on outputs produced by the one or more hidden layers to produce a final output. The selection of machine learning algorithm, loss function, and associated parameter and/or coefficient values can be variable depending on the requirements of the particular application system; e.g., the type of output desired to be produced and the nature of the inputs. Broadly speaking, using the output of a loss function as an input to a hidden layer of the neural network can be referred to as back propagation.

While FIG. 2 only shows one machine learning model 204, application system 130 can include or use any number of machine learning models. For example, a machine learning model 204 can be a pre-trained multi-task model produced by multi-task learning system 150, which is used as an embedding service that generates multi-task embeddings for downstream machine learning tasks. Another machine learning model 204 can be a version of a multi-task model created by multi-task learning system 150 that has been fine-tuned to produce domain-specific versions of multi-task embeddings for domain-specific portions of functionality 202.

Yet another machine learning model 204 can be a prediction model that generates predictions using, as inputs, outputs of a multi-task model (e.g., multi-task embeddings). For example, a machine learning model 204 can be a scoring model that outputs scores used to generate search suggestions or a ranking model that generates output used to rank search results. Machine learning model 204 can be hosted by a server computer or network of servers and/or portions of machine learning model 204 can be implemented on a client device, e.g., a user system 110.

Entity data 206 is a data store of application system 130 and/or data storage system 140 that stores entity data. An entity data record includes an entity identifier and one or more entity data. Entity data also can be referred to as attribute data. An entity data record can include or reference entity type data and/or entity profile data. Entity type data indicates an entity type associated with an entity identifier, e.g., person, organization, job, or content item. Entity profile data includes, for example, name, location, and job title. Portions of entity data can be stored in a table of a database, such as a nonrelational database, for example, a key-value store.

Activity data 208 is a data store of application system 130 and/or data storage system 140 that stores activity data records. An activity data record includes an activity identifier, an entity identifier, and a date/timestamp. An activity identifier can correspond to a user interface event identifier. For example, an activity data record can correspond to a user activity tracking event. An activity data record can include or reference activity type data. Activity type data can correspond to a particular type of front-end functionality.

Examples of activity type data include view, post, click, comment, share, like, follow, connect, comment, reply. An activity can include an activity type and an entity. Examples of entity-activity combinations include profile view, company view, people search, job search, job apply, article comment, post share, etc. Activity data 208 can be captured and stored as a real-time or near real-time data stream, for example in a real-time or nearline portion of data storage system 140.

Content item data 210 is a data store of application system 130 and/or data storage system 140 that stores digital content item data records. A digital content item data record can include a content item identifier, an entity identifier, and a date/timestamp. A digital content item data record can include a content item or a reference to a content item, such as a URL (uniform resource locator) of a content item.

Social graph 212 is a data store of application system 130 and/or data storage system 140 that stores graph-based representations of entities and inter-entity relationships. In social graph 212, entities are represented as nodes and inter-entity relationships are represented as edges. A node contains a node identifier and node type data. Node type data can correspond to an entity type. An edge contains node identifier data for two nodes connected by the edge and an edge type. Edge types correspond to different types of inter-entity relationships. Examples of inter-entity relationships include connection, like, follow, share, comment. An edge can connect two different node types. For example, an edge can represent a relationship between a person entity and a digital content item, or a person entity and an organization, or an organization and a job, or a person and a job.

Entity data 206, activity data 208, content item data 210, and social graph 212 are each in bidirectional digital communication with application system 130 generally or functionality 202 more specifically, via communicative couplings 220, 222, 224, 226, 228, respectively. That is, any of entity data 206, activity data 208, content item data 210, and social graph 212 can be implemented as part of application system 130 or as, e.g., cloud services that are external to application system 130.

Machine learning model 204 is in bidirectional digital communication with application system 130 generally or functionality 202 more specifically via communicative coupling 238. Task-specific portions of functionality 202, such as domain-specific recommenders, can issue calls or send data and/or instructions to machine learning model 204 over communicative coupling 238. Machine learning model 204 can issue calls or send data and/or instructions to various portions of functionality 202 via communicative coupling 238.

Machine learning model 204 is in bidirectional digital communication with multi-task learning system 150 via communicative coupling 228. Machine learning model 204 can issue calls or send data and/or instructions to multi-task learning system 150 over communicative coupling 228. Multi-task learning system 150 can issue calls or send data and/or instructions to machine learning model 204 over communicative coupling 228. Portions of multi-task learning system 150 can be implemented as or using, for example, an application program interface (API) hosted on a server computing device.

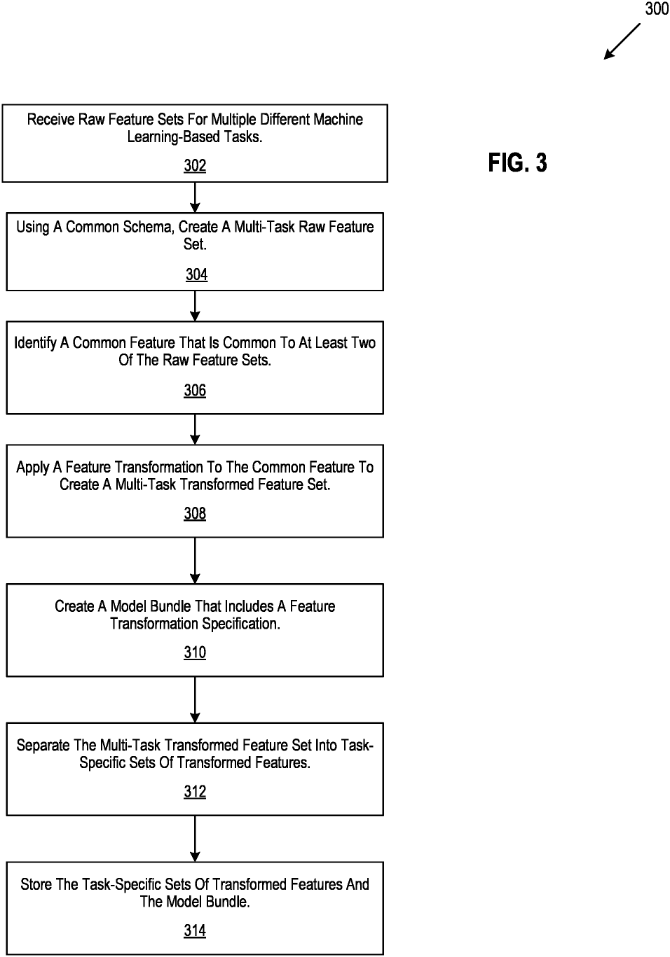

FIG. 3 is a flow diagram of an example method to generate training data for a multi-task machine learning model in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the multi-task learning system 150 of FIG. 1.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 302, the processing device receives heterogeneous raw feature sets for multiple different machine learning tasks. For example, the processing device can receive a first set of raw features arranged according to a first schema for a first machine learning task and a second set of raw features arranged according to a second schema different than the first schema for a second machine learning task different than the first machine learning task. The example of FIG. 3 refers to only two machine learning tasks only for ease of discussion. Method 300 can involve any number of machine learning tasks, and any number of corresponding task-specific schema and feature sets.

An example of a raw feature set is a set of raw data that can be used as or to generate training data for one or multiple machine learning tasks. Two types of heterogeneity are data heterogeneity and task heterogeneity. A heterogeneous raw feature set can be heterogeneous in one or more of these ways. Data heterogeneity can occur when raw data used as features is stored in different data stores that are configured according to different schema. As used herein, a schema can refer to a logical and/or physical organization of data, which specifies how the data is stored. A schema can specify, for instance, an arrangement of tables and fields in which different types of data are stored, and the way data are grouped together when stored. Fields as used herein can also be referred to as, for example, columns or entities.

For example, user features can be obtained from a user profile database that is arranged according to a user schema. The user schema may specify that user records are keyed by user identifier (ID) and contain fields for username, company name and job title. Job features can be obtained from a jobs database that is arranged according to a jobs schema. The jobs schema may specify that jobs records are keyed by job ID and contain fields for job title, company name, contact name, and location. In this example, both user ID and job ID have the features job title and company name in common. Since job title and company name are common features of both user ID and job ID, they can be shared.

Depending on the machine learning task, labels can be used to train a machine learning model. Task heterogeneity occurs when, even when the feature sets are the same, the labels used by different machine learning tasks are different.”. For example, a multi-task machine learning model for a feed ranking application can be trained for four different tasks. Each of the different tasks can use a different label that corresponds to a different feed activity, e.g., impression, view, share and comment.

The sparsity of different labels in the same training data set can be very different. Sparsity as used herein can refer to the distribution of different data values in a data set. Using the above example to illustrate sparsity, the feature set may contain a large number of impression records, a smaller number of view records, and an even smaller number of share and comment records. Sparsity can skew the data set and thereby impact the effectiveness of the machine learning model training. Data heterogeneity and/or task heterogeneity increases the complexity and decreases the efficiency of the machine learning model training.

To receive the feature sets, the processing device can, for example, query the data stores that store the feature sets and retrieve the query results.

At operation 304, the processing device creates a multi-task raw feature set using a common schema. To create the common schema, the processing device can combine the first and second schema and assign a feature identifier to each unique feature across the combined schema. Using the above example, the common schema can have feature 1 =username, feature2=job title, feature3=company name, feature 4= location.

After the common schema is created, the features of each task-specific raw feature set are mapped to corresponding feature identifiers in the common schema. In the example above, the features of the user feature set are mapped to feature 1, feature2, and features while the features of the job feature set are mapped to feature 1, feature2, features, and feature4. In this example, the contact name feature of the job feature set maps to feature 1 of the common schema while the location feature maps to feature4 of the common schema.

To create the multi-task feature set, the processing device can store the raw features in a common data store arranged according to the common schema. For example, the processing device can store the first set of raw features in a first row of the common data store and store the second set of raw features in a second row of the common data store.

Using the above example, all rows of the common data store have four columns, in accordance with the common schema; i.e., one column for each unique feature across all feature sets. The features of the user feature set are stored in the first three columns of the first row and the features of the job feature set are stored in the four columns of the second row, with the contact name feature being stored in the feature 1 position. Since the user feature set does not contain the location feature, a default value or dummy value, such as a null value, is stored in the feature4 position of the first row.

At operation 306, the processing device identifies a common feature that is common to at least two of the raw feature sets. Common features can be identified based on their feature identifiers. For example, to identify a common feature, the processing device can determine that a feature identifier in the first set of raw features matches a feature identifier in the second set of raw features.

Using the above example, both the user feature set and the job feature set contain features 1, 2, and 3; thus, features 1, 2, and 3 are common features with respect to the user feature set and the job feature set. Other feature sets can have different common features. Also, operation 306 is described as identifying “a” common feature merely for ease of discussion. In operation 306, any combination of feature sets can have any number of common features. Thus, as used herein, “identifying a common feature” can include “identifying one or more common features.”

At operation 308, the processing device applies a feature transformation to the common feature identified at operation 306 to create a multi-task transformed feature set. Since operation 306 can identify any number of common features, operation 308 can apply a different feature transformation to each of the common features identified in operation 306 across all of the task-specific feature sets. For example, operation 308 can identify the rows of the multi-task raw feature set that have the common feature (as determined, e.g., based on at least one column of a row having a matching feature ID with at least one column of another row), and then apply the feature transformation to the value of the common feature stored in the each of those rows.

An example of a feature transformation is a subsetting of a raw feature set. Using the sparse feature example, a feature transformer of operation 308 can sort a raw feature set based on a sort criteria such as number of occurrences. Operation 308 can then determine the top k feature values in the sorted feature set, where k is a positive integer or a percentage, and use those top k feature values as the transformed feature set.

In the example above, company name is a feature that is common to both the job feature set and the user feature set. However, in the raw data, there can be hundreds of thousands of different company names with many of those company names only having a few occurrences each. In this case, the feature transformation can be used to determine a less-sparse subset of company names, such as the top 20,000 company names in terms of number of occurrences. Other examples of feature transformations include feature crossings, e.g., applying a multiplication function to a combination of different features to produce a transformed feature that is a combination of the crossed features. Still other examples of feature transformations are aggregations, such as counts, averages, means, etc.

The feature transformations of operation 308 are performed after the task-specific raw feature sets have been merged into the common schema. This ensures that the feature transformations for common features are applied to their respective common features consistently across all of the task-specific raw feature sets.

Operation 308 also can perform feature transformations on features that are not common features. For example, the processing device can apply a task-specific feature transformation to a feature of the multi-task raw feature set that is not common a common feature, i.e., not contained in both the first set of raw features and the second set of raw features.

At operation 310, the processing device create a model bundle that includes a feature transformation specification for each of the feature transformation(s) performed in operation 308. A feature transformation specification includes a description of steps or instructions for applying the feature transformation to the feature. For example, the model bundle can include computer code that when executed by a processor performs the subsetting of a feature set or performs a crossing of two features. As noted above, different features can have different feature transformations. Thus, the model bundle can include multiple different feature transformation specifications that are each mapped to a corresponding feature.

The model bundle includes a feature transformation specification for each feature, including each common feature, that has a corresponding feature transformation. It is possible that some features, including some common features, will not need to be transformed, in which case those common features can be passed into the transformed feature set without having had a feature transformation applied. The determination of whether a particular feature is to be transformed can be made, for example, by operation 310 querying a pre-created feature configuration.

At operation 312, the processing device separates the multi-task transformed feature set into task-specific sets of transformed features. To enable operation 312, an additional column can be added to the common schema during the merging process of operation 304. The additional column can be used to store a feature set ID that uniquely identifies each task-specific feature set, e.g., by the machine learning task with which the task-specific feature set is associated. To separate the multi-task transformed feature set, the processing device can group the rows of the multi-task transformed feature set by feature set ID and split those groups into tasks-specific transformed feature sets.

At operation 314, the processing device stores the task-specific sets of transformed features and the model bundle. For example, the processing device can store the task-specific sets of transformed features and the model bundle in the same data store, which is arranged according to the common schema. Whether the task-specific sets of transformed features and the model bundle are stored in the same data store or different data stores, the model bundle and the task-specific sets of transformed features are logically linked in some way, e.g., as a “model training package” for creating a particular multi-task machine learning model.

Following operation 314, the processing device or another computing device or system can create a trained multi-task machine learning model by training a machine learning model using as inputs the first and second sets of transformed features and the model bundle. Also following operation 314, a trained multi-task machine learning model can be fine-tuned for a specific machine learning task, such as the first machine learning task or the second machine learning task.

Also following operation 314, a trained multi-task machine learning model can export multi-task embeddings on demand. For example, the multi-task embeddings exported by the multi-task machine learning model that has been trained using the model training package produced by operation 314 can be stored in a database that acts as an embedding service, which can be queried by downstream models or applications. The multi-task embeddings exported by the trained multi-task machine learning model can be used, for example, as inputs to a scoring model having a point-wise loss function for a search suggestion application and/or as inputs to a ranking model having a list-wise loss function for a search result ranking application.

A downstream vertical scoring model or ranking model can produce output based on multi-task embeddings generated by a multi-task machine learning model that has been trained using the model training package produced by operation 314. A downstream vertical model can support, for example, a recommendation or suggestion portion of front-end functionality 214 at a client device. For instance, front-end functionality 214 can configure or modify a recommendation or suggestion portion of a user interface, using output of a scoring model or a ranking model, where that model output is based on multi-task embeddings generated by the trained multi-task model. Configuring a user interface in this manner can include, for example, front-end functionality 214 changing the selection, order, or arrangement of digital content to be displayed in the user interface based on the output of the scoring model or ranking model.

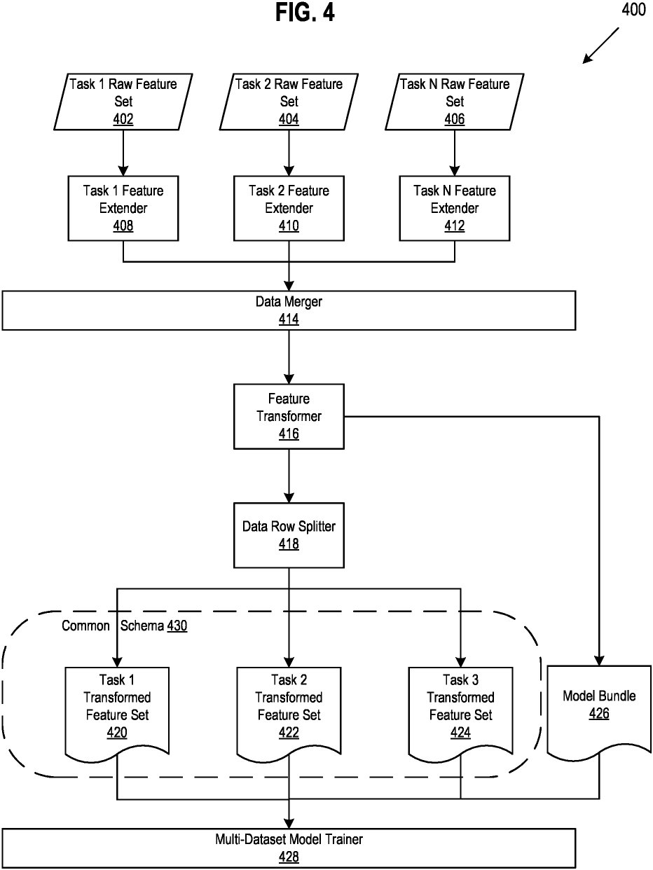

FIG. 4 is an example of a data preparation flow in accordance with some embodiments of the present disclosure. Data preparation flow 400 generates multi-task feature sets that can be used to train a multi-task model. In flow 400, a set of task-specific feature extenders 408, 410, 412 are applied to corresponding task-specific raw feature sets 402, 404, 406, such that there is a one-to-one correspondence between task-specific feature sets and task-specific feature extenders.

For example, in FIG. 4 there are N machine learning tasks, where N is a positive integer, and N raw feature sets, where each raw feature set 402, 404, 406 corresponds to a different machine learning task, and N feature extenders, where each feature extender 408, 410, 412 corresponds to a raw feature set. In other embodiments, a feature extender can apply to two or more raw feature sets. For instance, if two raw feature sets have the same schema and the same key, the same feature extender can be applied to both feature sets.

To illustrate, in FIG. 4, task 1 can be job search, task 2 can be user search, and task 3 can be job recommendation. Any of task 1 raw feature set 402, task 2 raw feature set 404, task N raw feature set 406 can be heterogeneous in any one or more of the ways described above (e.g., data heterogeneity and/or task heterogeneity).

Task 1 feature extender 408, task 2 feature extender 410, task N feature extender 412 prepare task 1 raw feature set 402, task 2 raw feature set 404, task N raw feature set 406, respectively, to be merged into a common schema. For example, each task-specific feature extender 408, 410, 412 extends the task-specific schema of its respective task-specific raw feature set 402, 404, 406 to include one or more columns that correspond to features that are in other feature sets of the task-specific raw feature sets 492, 404, 406 but not in its feature set. Each task-specific feature extender 408, 410, 412 inserts default values into the empty columns added to its particular task-specific schema. Each of the task-specific feature extenders 408, 410, 412 outputs an extended version of its respective task-specific raw feature set 402, 404, 406.

Data merger 414 takes the output of the task-specific feature extenders 408, 410, 412 and adds an additional column to each row of each of the extended task specific feature sets. Data merger 414 stores unique identifiers for each of the original task-specific raw feature sets 402, 404, 406 in the additional column. That is, each row of each extended task specific feature set produced by the task-specific feature extenders 408, 410, 412 is extended again by data merger 414 to contain a column in which the task-specific feature set ID is stored.

Data merger 414 then merges all of the extended task specific feature sets into the common schema to create a multi-task raw feature set in which there is one row in the common schema for each row of each of the task-specific raw feature set 402, 404, 406. In comparison to the rows of the original task-specific raw features sets 402, 404, 406, the corresponding rows in the multi-task raw feature set produced by data merger 414 are extended by the default values for the empty columns and by the additional column that stores the feature set ID.

Feature transformer 416 applies one or more feature transformations to the rows of the multi-task raw feature set produced by data merger 414, to create a multi-task transformed feature set, as described above with reference to FIG. 3. Feature transformer 416 also compiles the specifications for the feature transformations that have been performed on the multi-task raw feature set into model bundle 426. For example, model bundle 426 can contain a row for each task-specific raw feature set, where the row contains a description of the feature transformations that apply to that particular task-specific raw feature set.

Merging feature sets and applying the same feature transformer 416 to common features across multiple different machine learning tasks as described herein is considered counterintuitive. Other approaches have historically required feature joins and feature transformations to be performed separately for each task-specific feature set. For example, other approaches have operated on the assumption that features are task specific. As a result, other approaches have not shared feature transformations across tasks. In contrast, the disclosed technologies provide mechanisms for sharing feature transformations across common features of multiple different machine learning tasks.

Data row splitter 418 separates the multi-task transformed feature set produced by feature transformer 416 into task-specific sets of transformed features 420, 422, 424. The task-specific sets of transformed features 420, 422, 424 and model bundle 426 are stored according to the common schema 430.

The task-specific sets of transformed features 420, 422, 424 and model bundle 426 collectively can be used as inputs to a multi-dataset model trainer 428. Multi-dataset model trainer 428 can use the task-specific transformed feature sets 420, 422, 424 to train a multi-task machine learning model on multiple different feature sets. After the model is trained with the task-specific transformed features 420, 422, 424 and put into operation (e.g., into a prediction mode as opposed to a training mode), the model bundle 426 is used to ensure that new model inputs are transformed in the same manner as the training data using the same feature transformations that were applied to the training data.

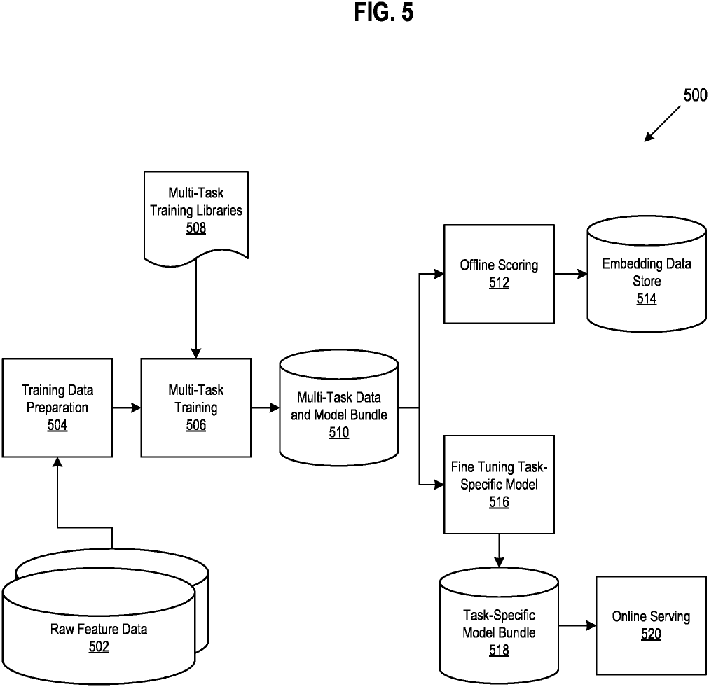

FIG. 5 is an example of a multi-task learning flow 500 in accordance with some embodiments of the present disclosure.

The flow 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, portions of the flow 500 are performed by the application system 130 and/or the multi-task learning system 150 of FIG. 1.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The components of FIG. 5 and flow 500 can be implemented as a generalized framework or multi-task learning pipeline that can support any type of multi-task model structure that may be used to support downstream vertical applications. Flow 500 is divided into four parts: training data preparation, training, scoring data preparation, and scoring. Flow 500 separates data preparation from training and scoring in order to accommodate the varying frequencies at which those operations can be updated and run.

During the data preparation stage, raw feature data is converted into multi-task training data that can be used to train a multi-task machine learning model. Other systems only allow a single input dataset for training. However, in flow 500, multi-task training block 506 is extended to support multiple different input data sets that are prepared by training data preparation block 504.

In flow 500, raw feature data 502 is ingested by training data preparation 504. For example, training data preparation 504 queries one or more databases to obtain various different raw features sets of raw feature data 502. Raw feature data 502 contains training examples, where each training example includes a set of raw data that can be used as features or to generate features for training a machine learning model for one or more tasks. Raw feature data 502 is heterogeneous in one or more of the ways described above (e.g., data heterogeneity and/or task heterogeneity), resulting in at least two of the raw feature sets having different task-specific schemas.

Training data preparation 504 converts the heterogeneous feature sets of raw feature data 502 into the same schema, e.g., a common schema, and merges the raw feature sets to create a single, multi-task raw feature set. Training data preparation 504 appends an additional column to the multi-task raw feature set and inserts the original feature set identifier in the additional column. Training data preparation 504 inserts dummy values in additional columns added to the feature sets to align the task-specific schemas with the common schema, as described above.

Training data preparation 504 applies one or more feature transformations to the multi-task raw feature set, as described above, to produce a multi-task transformed feature set. Training data preparation 504 splits the multi-task transformed feature into task-specific transformed feature sets that contain the transformed features. The separate task-specific transformed feature sets along with a model bundle generated as a result of the feature transformations can then serve as inputs to the training pipeline.

Multi-task training block 506 allows for multiple input data sets with the same schema and one transformation model bundle as the input. The task-specific transformed feature sets produced by training data preparation 504 all have the same schema (e.g., the common schema), and one model bundle.

Multi-task training block 506 includes an importer to import the training data sets produced by training data preparation 504 and an importer for the model bundle. Multi-task training 506 includes a model trainer that trains a machine learning model using the imported training data sets and one or more multi-task training libraries 508. Multi-task training libraries 508 can include, for example, model layer and/or model architecture definitions and model training methods for a wide variety of different types of machine learning models.

Multi-task training 506 is configured for iterative training and/or joint training. In iterative training, the model training iterates among different task-specific training datasets, for example according to pre-defined task weights. During iterative training, the different tasks’ learning rates and/or frequencies can be adjusted in order to balance different tasks’ impact on shared layers of the model. Also during iterative training, the backpropagation of loss gradients can be alternated among different tasks, i.e., different tasks take turns backpropagating their loss gradients.

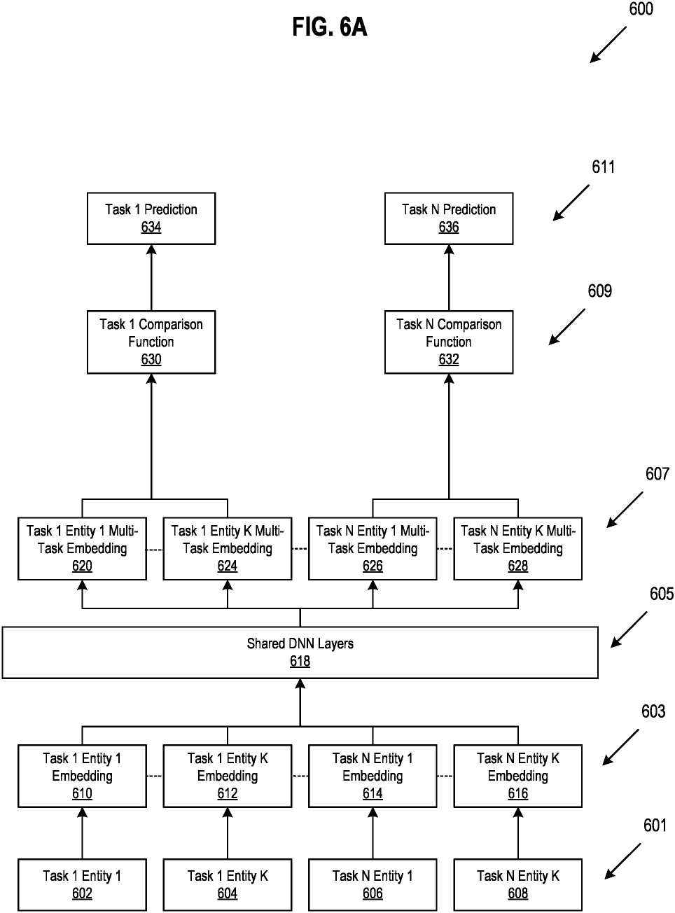

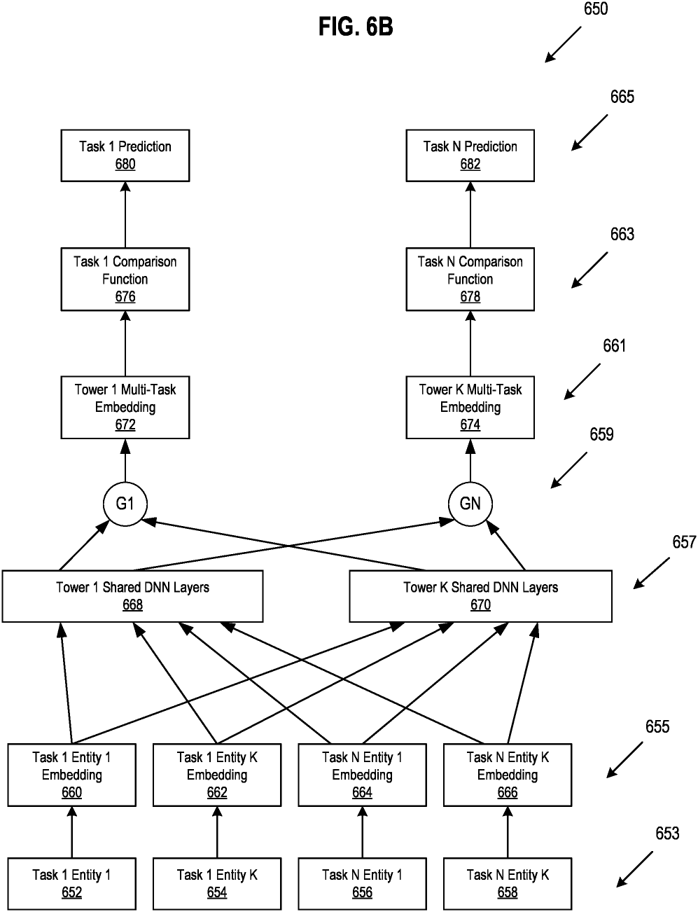

Training the multi-task machine learning model can include sharing some or all of the layers of the machine learning model across different tasks. For example, features, coefficients, parameters, and loss functions can be shared. In some implementations, soft sharing is used to enable sharing only between tasks that have the same loss function. In other implementations, hard sharing is used to enable features to be shared across all of the tasks for which the machine learning model is being trained. FIG. 6A, described below, illustrates an example of a model architecture that uses hard sharing. FIG. 6B, described below, illustrates an example of a model architecture that users soft sharing. The model trainer can be implemented using, for example, KERAS APIs. Multi-task training 506 includes an exporter that exports the trained multi-task model.

In multi-task training, the machine learning model can be trained for multiple different tasks at the same time. However, the training for different tasks may be completed at different learning rates. Once training finishes for all of the tasks, a post-training version of the multi-task data and model bundle 510 can be exported and stored for easy retrieval by different downstream applications.

Offline scoring block 512 can use the trained multi-task model to generate multi-task embeddings as a service. For example, offline scoring 512 can run as a batch process that periodically generates multi-task embeddings for new entities that have been created in an application system 130. In other embodiments, portions of offline scoring 512 can be implemented using real-time or nearline data processing methods. The multi-task embeddings can be stored in embedding data store 514 for querying by downstream models and/or applications.

Fine tuning task-specific model block 516 can apply task-specific training sets to a pre-trained multi-task model produced by multi-task training 506 in order to fine tune the multi-task model for a specific task. Fine tuning task-specific model 516 produces, as a result of the fine tuning, a task-specific model bundle 518. Online serving block 520 can make the task-specific fine-tuned multi-task model produced by fine tuning block 516 accessible for the task-specific downstream application for which it was fine-tuned. For example, online serving 520 can bring the fine-tuned version of the multi-task model online for communication with a portion of functionality 202, described above.

FIG. 6A and FIG. 6B are examples of machine learning model architectures for multi-task learning in accordance with some embodiments of the present disclosure. FIG. 6A is an example of a machine learning model architecture 600 for multi-task learning that has been configured with hard sharing. The machine learning model architecture 600 can be stored in memory, for example using a combination of data structures and computer code. FIG. 6A illustrates a situation in which different entities (e.g., title, job) share the same layers and in the end have one unified embedding. Another example of hard sharing (now shown) is a situation on which different entities(e.g., title, job) don’t share layers and in the end have 2 separate embeddings. These are both examples of hard sharing because the same layers are used for the different tasks.

In FIG. 6A, model architecture 600 includes an input layer 601, a single-task embedding layer 603 coupled to the input layer 601, shared DNN layers 618 coupled to single-task embedding layer 603, multi-task embeddings 607 output by the shared DNN layers 618, a comparison layer 609 that operates on the multi-task embeddings 607, and a prediction layer 611 coupled to comparison layer 609.

At input layer 601, there is an input for each entity of K entities of each task of N machine learning tasks, where K and N each are a positive integer greater than or equal to 2, and the value of K can be different for each task. For purposes of illustration, Task 1 and Task N are different but related tasks. For example, Task 1 can be to predict a job co-occurrence for job smart suggestions, while Task N is to predict a user co-occurrence for user smart suggestions. As another example, Task 1 can be to predict entity-entity co-sessions while Task N can be to predict the likelihood that a user will submit a job application.

The entities received at input layer 601 can be different for different tasks. For example, if Task 1 is job entity c-occurrence, where the co-occurrence prediction is used to by smart suggestion functionality to determine whether to suggest a job entity, task 1 entity 1 and task 1 entity K can be different job entities, for example, software engineer and software architect. Also, for co-occurrence tasks, K=2. Other examples of entities include user entities, where each user entity corresponds to a different user profile, and query entities, where each query entity corresponds to a different set of query results.

At single task embedding layer 603, an entity embedding is determined for each of the entities received at input layer 601. Thus, for task 1 entity 1 602, a task 1 entity 1 embedding 610 is determined. For task 1 entity K 604, a task 1 entity K embedding 612 is determined. For task N entity 1 606, a task N entity 1 embedding 614 is determined. For task N entity K 608, a task N entity K embedding 616 is determined. Embeddings 610, 612, 614, 616 can be determined by, for example, performing a lookup on a database of standardized embeddings or using a publicly available embedding service such as WORD2VEC.

Shared DNN layers 618 are a multi-task deep neural network (DNN) that has been trained to generate multi-task embeddings using the technologies described herein. Shared DNN layers 618 generate a multi-task embedding for each entity embedding 610, 612, 614, 616. Thus, for task 1 entity 1 embedding 610, shared DNN layers 618 generate task 1 entity 1 multi-task embedding 620. For task 1 entity K embedding 612, shared DNN layers 618 generate task 1 entity k multi-task embedding 624. For task N entity 1 embedding 614, shared DNN layers 618 generate task N entity 1 multi-task embedding 626. For task N entity K embedding 616, shared DNN layers 618 generate task N entity K multi-task embedding 628.

Shared DNN layers 618 are configured for hard sharing. Thus, in producing the multi-task embeddings 620, 624, 626, 628, model parameters, coefficients, features, and loss functions can be shared across all of the N tasks.

Multi-task embeddings 620, 624, 626, 628 are different than entity embeddings 610, 612, 614, 616, because multi-task embeddings 620, 624, 626, 628 are generated by the shared DNN layers 618 sharing information across the tasks. For example, the shared DNN layers 618 enable task N entity embeddings 614, 616 to be shared with task 1 and task 1 embeddings 610, 612 to be shared with task N.

Comparison layer 609 includes a comparison function node for each task. Thus, comparison layer 609 will have a total of N nodes. Each comparison function node 630, 632 performs an operation on a pair of multi-task embedding inputs. The operation performed by a comparison function node is to measures the semantic similarity of the embedding inputs. Thus, task 1 comparison function 630 measures the semantic similarity between multi-task embedding 620 and multi-task embedding 624 while task N comparison function 632 measures the semantic similarity between multi-task embedding 626 and multi-task embedding 628. Examples of operations that can be used to implement comparison functions 630, 632 include multiplication operations such as the Hadamard product, or cosine similarity.

The outputs of comparison layer 609 are the scores that correspond to task-specific predictions. Thus, prediction layer 611 contains one prediction for each task for a total of N predictions. For example, a high score output by a comparison function 630, 632 can result in a prediction 634, 636 of a high degree of similarity between two multi-task embeddings, and a low score can indicate a prediction 634, 636 of a low degree of similarity between two multi-task embeddings. Using task 1 as an example, if the score output by comparison function 630 is above a threshold, the prediction 634 can be used by a downstream smart suggestion application to display or otherwise present task 1 entity K as a suggestion if the user inputs entity 1. Conversely, if the score output by comparison function 630 is below the threshold, the prediction 634 can be used by the downstream smart suggestion application to not display task 1 entity K as a suggestion in a search interface if the user inputs entity 1.

FIG. 6B is an example of a machine learning model architecture 650 for multi-task learning that has been configured with soft sharing.

Architecture 650 includes an input layer 653, an entity embedding layer 655, a shared DNN layer 657, task-specific weights 659, a multi-task embedding layer 6661, a comparison function layer 663, and a prediction layer 665.

Architecture 650 of FIG. 6B is similar to architecture 600 of FIG. 6A in that the description of input layer 601 of FIG. 6A applies to input layer 653 of FIG. 6B, the description of entity embedding layer 605 applies to entity embedding layer 655, the description of comparison layer 609 applies to comparison layer 663, and the description of prediction layer 611 applies to prediction layer 665.

In architecture 650, however, shared DNN layers 657 are divided into entity specific shared DNN layers 668, 670 (“towers”) rather than having all DNN layers shared as in FIG. 6A. For example, tower 1 shared DNN layers 668 are a portion of the shared DNN layers 657 that are shared by task 1 and task N only for entity 1. Similarly, tower K shared DNN layers 670 are another portion of the shared DNN layers 657 that are shared by task 1 and task N only for entity K.

Thus, in comparison to FIG. 6A, in the architecture 650 of FIG. 6B, the shared DNN layers change from the unified hard sharing DNN layer 618 of FIG. 6A to task specific shared DNN layers 668, 670. Weighted combinations (e.g., summations) of the different (task specific) shared DNN layers 668, 670 produce embeddings 672, 674 in FIG. 6B. The weights (G1, GN) of layer 659 are task-specific and thus can attain different values through training. As a result, the outputs of G1 and GN, e.g., combined shared DNN*G layers, will be similar but different (thus “soft”). FIG. 6B illustrates only one example of soft sharing; there are many other ways to configure soft sharing.

FIG. 7 illustrates an example machine of a computer system 700 within which a set of instructions, for causing the machine to perform any one or more of the methodologies discussed herein, can be executed. In some embodiments, the computer system 700 can correspond to a component of a networked computer system (e.g., the computer system 100 of FIG. 1) that includes, is coupled to, or utilizes a machine to execute an operating system to perform operations corresponding to the multi-task learning system 150 of FIG. 1. In one embodiment, instructions 712, 714, 744 include instructions to implement functionality corresponding to the multi-task learning system 150 of FIG. 1 and/or software embodying any one or more of the methodologies or functions described herein.

The machine is connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random-access memory (DRAM) such as synchronous DRAM (SDRAM) or Rambus DRAM (RDRAM), etc.), a memory 706 (e.g., flash memory, static random-access memory (SRAM), etc.), an input/output system 710, and a data storage system 740, which communicate with each other via a bus 730.

The main memory 704 is configured to store instructions 714 for performing the operations and steps discussed herein. Instructions 714 include portions of multi-task learning system 150 when those portions of multi-task learning system 150 are stored in main memory 704. Thus, multi-task learning system 150 is shown in dashed lines as part of instructions 714 to illustrate that portions of multi-task learning system 150 can be stored in main memory 704. However, it is not required that multi-task learning system 150 be embodied entirely in instructions 714 at any given time and portions of multi-task learning system 150 can be stored in other components of computer system 700.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 712 for performing the operations and steps discussed herein.

Instructions 712 include portions of multi-task learning system 150 when those portions of multi-task learning system 150 are being executed by processing device 702. Thus, similar to the description above, multi-task learning system 150 is shown in dashed lines as part of instructions 712 to illustrate that, at times, portions of multi-task learning system 150 are executed by processing device 702. For example, when at least some portion of multi-task learning system 150 is embodied in instructions to cause processing device 702 to perform the method(s) described above, some of those instructions can be read into processing device 702 (e.g., into an internal cache or other memory) from main memory 704 and/or data storage system 740. However, it is not required that all of multi-task learning system 150 be included in instructions 712 at the same time and portions of multi-task learning system 150 are stored in one or more other components of computer system 700 at other times, e.g., when one or more portions of multi-task learning system 150 are not being executed by processing device 702.

The computer system 700 can further include a network interface device 708 to communicate over the network 720. Network interface device 708 can provide a two-way data communication coupling to a network. For example, network interface device 708 can be an integrated-services digital network (ISDN) card, cable modem, satellite modem, or a modem to provide a data communication connection to a corresponding type of telephone line. As another example, network interface device 708 can be a local area network (LAN) card to provide a data communication connection to a compatible LAN. Wireless links can also be implemented. In any such implementation network interface device 708 can send and receives electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 700.

Computer system 700 can send messages and receive data, including program code, through the network(s) and network interface device 708. In the Internet example, a server can transmit a requested code for an application program through the Internet and network interface device 708. The received code can be executed by processing device 702 as it is received, and/or stored in data storage system 740, or other non-volatile storage for later execution.

The input/output system 710 can include an output device, such as a display, for example a liquid crystal display (LCD) or a touchscreen display, for displaying information to a computer user, or a speaker, a haptic device, or another form of output device. The input/output system 710 can include an input device, for example, alphanumeric keys and other keys configured for communicating information and command selections to processing device 702.

An input device can, alternatively or in addition, include a cursor control, such as a mouse, a trackball, or cursor direction keys for communicating direction information and command selections to processing device 702 and for controlling cursor movement on a display. An input device can, alternatively or in addition, include a microphone, a sensor, or an array of sensors, for communicating sensed information to processing device 702. Sensed information can include voice commands, audio signals, geographic location information, and/or digital imagery, for example.

The data storage system 740 can include a machine-readable storage medium 742 (also known as a computer-readable medium) on which is stored one or more sets of instructions 744 or software embodying any one or more of the methodologies or functions described herein. The instructions 744 can also reside, completely or at least partially, within the main memory 704 and/or within the processing device 702 during execution thereof by the computer system 700, the main memory 704 and the processing device 702 also constituting machine-readable storage media.

In one embodiment, the instructions 744 include instructions to implement functionality corresponding to a multi-task learning component (e.g., the multi-task learning system 150 of FIG. 1). Multi-task learning system 150 is shown in dashed lines as part of instructions 744 to illustrate that, similar to the description above, portions of multi-task learning system 150 can be stored in data storage system 740 alternatively or in addition to being stored within other components of computer system 700.

Dashed lines are used in FIG. 7 to indicate that it is not required that multi-task learning system 150 be embodied entirely in instructions 712, 714, and 744 at the same time. In one example, portions of multi-task learning system 150 are embodied in instructions 744, which are read into main memory 704 as instructions 714, and portions of instructions 714 are read into processing device 702 as instructions 712 for execution. In another example, some portions of multi-task learning system 150 are embodied in instructions 744 while other portions are embodied in instructions 714 and still other portions are embodied in instructions 712.

While the machine-readable storage medium 742 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system’s registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100, can carry out the computer-implemented methods and flows described above in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies can include any of the examples or a combination of the described below.

In an example 1, a method includes receiving, for a first machine learning task, a first set of raw features arranged according to a first schema, and, for a second machine learning task different than the first machine learning task, a second set of raw features arranged according to a second schema different than the first schema; converting the first schema and the second schema to a common schema; creating a multi-task raw feature set by storing, in a data store arranged according to the common schema, a first row including the first set of raw features and a second row including the second set of raw features; identifying a common feature that is common to both the first set of raw features and the second set of raw features; creating a multi-task transformed feature set by applying a feature transformation to the common feature; creating a model bundle that includes a specification for applying the feature transformation to the common feature; separating the multi-task transformed feature set into first and second sets of transformed features; and creating a trained multi-task machine learning model by training a machine learning model using as inputs the first and second sets of transformed features and the model bundle.

An example 2 includes the subject matter of example 1, further including assigning a feature identifier to each unique feature of the first schema and the second schema. An example 3 includes the subject matter of example 1 or example 2, further including, in a portion of the first row that corresponds to the second schema but does not correspond to the first schema, storing a default value. An example 4 includes the subject matter of any of examples 1-3, further including identifying the common feature based on identifying a unique feature identifier in the first set of raw features and identifying the same unique feature identifier in the second set of raw features. An example 5 includes the subject matter of any of examples 1-4, further including applying the feature transformation to a first value of the common feature stored in the first row, and applying the same feature transformation to a second value of the common feature stored in the second row. An example 6 includes the subject matter of any of examples 1-5, further including applying a task-specific feature transformation that is specific to the first machine learning task or the second machine learning task to a feature of the multi-task raw feature set that is not common to both the first set of raw features and the second set of raw features. An example 7 includes the subject matter of any of examples 1-6, further including storing the model bundle in the data store arranged according to the common schema. An example 8 includes the subject matter of any of examples 1-7, further including fine-tuning the trained multi-task machine learning model for the first machine learning task or the second machine learning task. An example 9 includes the subject matter of any of examples 1-8, further including exporting, by the trained multi-task machine learning model, a multi-task embedding usable as an input to a scoring model having a point-wise loss function for a search suggestion application and as an input to a ranking model having a list-wise loss function for a search result ranking application. An example 10 includes the subject matter of any of examples 1-9, where training the machine learning model includes applying a same value of a coefficient of a layer of the machine learning model to both the first machine learning task and the second machine learning task. An example 11 includes the subject matter of any of examples 1-10, where training the machine learning model includes applying a same value of a parameter of the machine learning model to both the first machine learning task and the second machine learning task. An example 12 includes the subject matter of any of examples 1-11, further including first training the machine learning model for the first machine learning task using the first set of transformed features, back-propagating a first loss gradient produced by the first training, second training the machine learning model for the second machine learning task using the second set of transformed features, and back-propagating a second loss gradient produced by the second training.

In an example 13, a method includes receiving, for a first machine learning task, a first set of raw features arranged according to a first schema, and, for a second machine learning task different than the first machine learning task, a second set of raw features arranged according to a second schema different than the first schema; converting the first schema and the second schema to a common schema; creating a multi-task raw feature set by storing, in a data store arranged according to the common schema, a first row including the first set of raw features and a second row including the second set of raw features; identifying a common feature that is common to both the first set of raw features and the second set of raw features; creating a multi-task transformed feature set by applying a feature transformation to the common feature; creating a model bundle that includes a specification for applying the feature transformation to the common feature; separating the multi-task transformed feature set into first and second sets of transformed features; and storing the first and second sets of transformed features and the model bundle in the data store arranged according to the common schema.

An example 14 includes the subject matter of example 13, further including, in a portion of the first row that corresponds to the second schema but does not correspond to the first schema, storing a first default value; and, in a portion of the second row that corresponds to the first schema but does not correspond to the second schema, storing a second default value. An example 15 includes the subject matter of example 13 or example 14, further including applying the feature transformation to a first value of the common feature stored in the first row, and applying the same feature transformation to a second value of the common feature stored in the second row.

In an example 16, a system includes memory configured according to a machine learning model, the machine learning model including: an input layer to receive heterogeneous input data for a plurality of different machine learning tasks; a single-task entity embedding lookup layer coupled to the input layer; a multi-task deep neural network (DNN) coupled to output of the single-task entity embedding lookup layer; and a prediction layer coupled to an output layer of the multi-task DNN; and means for preparing the heterogeneous input data to be received by the input layer.

An example 17 includes the subject matter of example 16, where the multi-task deep neural network (DNN) of the machine learning model further includes a first sub-network of shared layers that are shared by a first subset of the heterogeneous input data and a second sub-network of shared layers that are shared by a second subset of the heterogeneous input data different than the first subset. An example 18 includes the subject matter of example 16 or example 17, where the multi-task deep neural network (DNN) of the machine learning model further includes a first sub-network configured to output first multi-task embedding data in response to a first subset of the heterogeneous input data and a second sub-network configured to output second multi-task embedding data in response to a second subset of the heterogeneous input data. An example 19 includes the subject matter of any of examples 16-18, where the prediction layer of the machine learning model further includes a first prediction node configured to output a first prediction for a first machine learning task and a second prediction node configured to output a second prediction different than the first prediction for a second machine learning task. An example 20 includes the subject matter of any of examples 16-19, where the machine learning model further includes an operation layer interposed between the multi-task deep neural network (DNN) and the prediction layer and configured to perform a comparison operation on multi-task embedding data output by different sub-networks of the multi-task DNN.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving, for a first machine learning task, a first set of raw features arranged according to a first schema, and, for a second machine learning task different than the first machine learning task, a second set of raw features arranged according to a second schema different than the first schema;
converting the first schema and the second schema to a common schema;
creating a multi-task raw feature set by storing, in a data store arranged according to the common schema, a first row comprising the first set of raw features and a second row comprising the second set of raw features;
identifying a common feature that is common to both the first set of raw features and the second set of raw features;
creating a multi-task transformed feature set by applying a feature transformation to the common feature;
creating a model bundle that includes a specification for applying the feature transformation to the common feature;
separating the multi-task transformed feature set into first and second sets of transformed features; and
creating a trained multi-task machine learning model by training a machine learning model using as inputs the first and second sets of transformed features and the model bundle.

2. The method of claim 1, further comprising assigning a feature identifier to each unique feature of the first schema and the second schema.

3. The method of claim 1, further comprising, in a portion of the first row that corresponds to the second schema but does not correspond to the first schema, storing a default value.

4. The method of claim 1, further comprising identifying the common feature based on identifying a unique feature identifier in the first set of raw features and identifying the same unique feature identifier in the second set of raw features.

5. The method of claim 1, further comprising applying the feature transformation to a first value of the common feature stored in the first row, and applying the same feature transformation to a second value of the common feature stored in the second row.

6. The method of claim 1, further comprising applying a task-specific feature transformation that is specific to the first machine learning task or the second machine learning task to a feature of the multi-task raw feature set that is not common to both the first set of raw features and the second set of raw features.

7. The method of claim 1, further comprising storing the model bundle in the data store arranged according to the common schema.

8. The method of claim 1, further comprising fine-tuning the trained multi-task machine learning model for the first machine learning task or the second machine learning task.

9. The method of claim 1, further comprising exporting, by the trained multi-task machine learning model, a multi-task embedding usable as an input to a scoring model having a point-wise loss function for a search suggestion application and as an input to a ranking model having a list-wise loss function for a search result ranking application.

10. The method of claim 1, wherein training the machine learning model comprises applying a same value of a coefficient of a layer of the machine learning model to both the first machine learning task and the second machine learning task.

11. The method of claim 1, wherein training the machine learning model comprises applying a same value of a parameter of the machine learning model to both the first machine learning task and the second machine learning task.

12. The method of claim 1, further comprising first training the machine learning model for the first machine learning task using the first set of transformed features, back-propagating a first loss gradient produced by the first training, second training the machine learning model for the second machine learning task using the second set of transformed features, and back-propagating a second loss gradient produced by the second training.

13. A method comprising:
receiving, for a first machine learning task, a first set of raw features arranged according to a first schema, and, for a second machine learning task different than the first machine learning task, a second set of raw features arranged according to a second schema different than the first schema;
converting the first schema and the second schema to a common schema;
creating a multi-task raw feature set by storing, in a data store arranged according to the common schema, a first row comprising the first set of raw features and a second row comprising the second set of raw features;
identifying a common feature that is common to both the first set of raw features and the second set of raw features;
creating a multi-task transformed feature set by applying a feature transformation to the common feature;
creating a model bundle that includes a specification for applying the feature transformation to the common feature;
separating the multi-task transformed feature set into first and second sets of transformed features; and
storing the first and second sets of transformed features and the model bundle in the data store arranged according to the common schema.

14. The method of claim 13, further comprising, in a portion of the first row that corresponds to the second schema but does not correspond to the first schema, storing a first default value; and, in a portion of the second row that corresponds to the first schema but does not correspond to the second schema, storing a second default value.

15. The method of claim 13, further comprising applying the feature transformation to a first value of the common feature stored in the first row, and applying the same feature transformation to a second value of the common feature stored in the second row.

16. A system comprising:
memory configured according to a machine learning model, the machine learning model including:
an input layer to receive heterogeneous input data for a plurality of different machine learning tasks;
a single-task entity embedding lookup layer coupled to the input layer;
a multi-task deep neural network (DNN) coupled to output of the single-task entity embedding lookup layer; and
a prediction layer coupled to an output layer of the multi-task DNN; and
means for preparing the heterogeneous input data to be received by the input layer.

17. The system of claim 16, wherein the multi-task deep neural network (DNN) of the machine learning model further includes a first sub-network of shared layers that are shared by a first subset of the heterogeneous input data and a second sub-network of shared layers that are shared by a second subset of the heterogeneous input data different than the first subset.

18. The system of claim 16, wherein the multi-task deep neural network (DNN) of the machine learning model further includes a first sub-network configured to output first multi-task embedding data in response to a first subset of the heterogeneous input data and a second sub-network configured to output second multi-task embedding data in response to a second subset of the heterogeneous input data.

19. The system of claim 16, wherein the prediction layer of the machine learning model further includes a first prediction node configured to output a first prediction for a first machine learning task and a second prediction node configured to output a second prediction different than the first prediction for a second machine learning task.

20. The system of claim 16, wherein the machine learning model further includes an operation layer interposed between the multi-task deep neural network (DNN) and the prediction layer and configured to perform a comparison operation on multi-task embedding data output by different sub-networks of the multi-task DNN.
